(19) United States
(12) Patent Application Publication
(10) Pub. No.: US 2001/0032180 A1
(43) Pub. Date: Oct. 18, 2001

(54) System for carrying out a commercial transaction with a high security and efficiency

(76) Inventors: Katsushi Takami, Tokyo (JP); Daisuke Matsuo, Tokyo (JP)

Correspondence Address: SHLESINGER, ARKWRIGHT & GARVEY LLP, 3000 South Eads Street, Arlington, VA, 22202, US

(21) Appl. No.: 09/808,147

(22) Filed: Mar. 15, 2001

(30) Foreign Application Priority Data
Mar. 16, 2000 (JP) 2000-73457

(51) Int. Cl. G06F 17/60

(52) U.S. Cl. 705/39; 705/40; 705/35; 705/42; 705/26

(57) ABSTRACT

A bank opens an account which is for use in money is deposited as input money by a buyer. A market management agency communicates with a seller, the buyer, and the bank to process information concerned to the commercial transaction, into processed information. The market management agency keeps the processed information therein. The market management agency produces a bill and statement data having a billed amount on the basis of a purchase request of the buyer to supply the bill and statement data to the buyer and the bank. The market management agency carries out check processing which is for judging whether or not the input money is coincident with the billed amount of the bill and statement data when the input memory is deposited into the account. The market management agency produces an instruction of a merchandise delivery when the input money is coincident with the billed amount. The bank pays a merchandise price within the input money to the seller in response to the completing notice. As a result, it is possible to evade a risk in a commercial transaction. Furthermore, it is possible to carry out a merchandise transaction with a high security and efficiency.

### BACKGROUND OF THE INVENTION

This invention relates to a commercial transaction which is carried out in a commercial market, and more particularly, to a system for use in carrying out merchandise delivery and payment between a seller and a buyer.

In general, a commercial transaction leads to an end when a seller delivers merchandise or goods to a buyer and when the buyer pays for the goods. In a commercial market, merchandise delivery and payment are carried out between the seller and the buyer. Each of the seller and the buyer may be called a concerned party. Each of the seller and the buyer inevitably has a risk on the merchandise delivery and the payment. More particularly, the buyer may not pay for the goods even if the seller delivers the goods to the buyer. On the other hand, the seller may not deliver the goods to the buyer even if the buyer pays for the goods. In addition, the seller may deliver the buyer other goods different from the goods for which the buyer pays. Even if the buyer returns the other goods to the seller, the seller may not pay back money to the buyer. Taking the above-mentioned problems into consideration, it is desirable that the seller delivers the goods to the buyer after the buyer pays for the goods. To the contrary, it is desirable that the buyer pays for the goods after the goods are delivered to the buyer and the buyer makes sure whether or not the goods is wrong. However, it is impossible to give satisfaction to both of the seller and the buyer at the same time. It is necessary for at least one of the seller and the buyer to take a risk in concern to the merchandise transaction.

The risk factor is so low inasmuch as it is possible to gauge credibility on the basis of previous actual results, in case where the concerned party is under continuous merchandise transaction. In an open market, it often occurs that the seller has no previous transaction result for the buyer. In this case, it is difficult for each of the seller and the buyer to gauge mutual credibility. In order to reduce the risk for the merchandise transaction, the seller may deliver the goods to the buyer when the buyer pays a part of price for the goods. After the goods are delivered to the buyer, the buyer pays a remaining price for the goods. To the contrary, the buyer may pay the price for the goods when the seller delivers a part of the goods to the buyer. After that, the seller delivers a remaining part of the goods to the buyer. However, it is difficult to remove the risk in concern to the merchandise transaction.

### SUMMARY OF THE INVENTION

It is an object of this invention to provide a system for carrying out merchandise transaction with high security and efficiency in case where it is impossible for each of seller and buyer to gauge mutual credibility.

Other objects of this invention will become clear as the description proceeds.

According to this invention, there is provided a system for use in carrying out a commercial transaction between a seller and a buyer with a high security. The system comprises a bank having an account for keeping money which is deposited as input money by the buyer, a market management agency for communicating with the seller, the buyer, and the bank, and first means for carrying out check processing which is for judging whether or not the input money is coincident with a billed amount of a bill and statement data when the input memory is deposited into the account. The first means produces a coincidence signal when the input money is coincident with the billed amount. The market management agency comprises second means for processing information concerned to the commercial transaction, into processed information, third means for keeping the processed information therein, fourth means for producing the bill and statement data having the billed amount on the basis of a purchase request of the buyer to supply the bill and statement data to the buyer and the bank, fifth means for producing an instruction of a merchandise delivery in response to the coincidence signal, and sixth means for informing the bank of a completing notice after delivery of the goods is completed. The bank comprises seventh means for keeping the input money as kept money in the account in response to the coincidence signal and eighth means for paying a merchandise price within the input money to the seller in response to the completing notice.

The fourth means may make the bill and statement data have account number data which is for use in deposing the input money into the bank, on supplying the bill and statement data to the buyer. At least one of the bank and the market management agency may carry out the check processing. The market management agency further comprises a database for memorizing information concerned to the seller and goods of the seller, as seller data therein. The fourth means reads the seller data out of the database on the basis of the purchase request to produce the bill and statement on the basis of the seller data.

In addition, either one of the bank and the market management agency comprises ninth means for producing a fund transferring data representative of transferring money to the seller, as a seller transferring data, before the merchandise price is paid within the kept money to the seller. The ninth means further produces a payment statement data concerned to the transfer of money. Either one of the bank and the market management agency comprises tenth means for producing a fund transferring data representative of transferring money to the market management agency, as an agency transferring data, before a fee is paid within the kept money to the market management agency.

Furthermore, a delivery service sends a receipt completing notice to the market management agency after the delivery service delivers the goods to the buyer, in case of requesting the delivery service to deliver the goods from the seller to the buyer. Either one of the bank and the market management agency comprises eleventh means for producing a fund transferring data representative of transferring money to the delivery service, as a delivery transferring data, before a freight is paid within the kept money to the delivery service. There may be a plurality of sellers.

In addition, the first means produces a non-coincidence signal when the input money is not coincident with the billed amount. The system further comprises a twelfth means for transferring the kept money to another account which is predetermined by the bank and the market management agency, in response to the non-coincidence signal. The twelfth means inquires of the buyer about the input money.

The buyer informs the market management agency that the buyer returns the goods to the seller, in case where the buyer returns the goods to the seller. The market management agency requests the bank to return the input money back to the buyer when the buyer informs the market management agency that the buyer returns the goods to the seller. The bank returns the input money back to the buyer when the market management agency requests the bank to return the input money back to the buyer.

Either one of the seller and the buyer may exist in one of foreign countries.

The buyer uses one selected from a first method of transferring the input money into the bank, a second method of paying the input money in a convenience store, a third method of an account transfer, a fourth method of cash of delivery, a fifth method of a postal transfer, and sixth method of paying the input money by electric money.

The bank may underwrite a debt obligation of the buyer. Alternatively, the bank manages the input money on the basis of trust.

### BRIEF DESCRIPTION OF THE DRAWINGS

FIG. 1 shows a view for illustrating a conventional merchandise transaction system;

FIG. 2A shows a view for describing a concept of a merchandise transaction system of this invention in debt underwriting method;

FIG. 2B shows a view for describing a concept of a merchandise transaction system of this invention in fund trust method;

FIG. 3 is a shows a schematic view of a merchandise transaction system according to a preferred embodiment of this invention;

FIG. 4 is a block diagram of a merchandise transaction system according to a preferred embodiment of this invention;

FIG. 5 is a flow chart for describing an operation of the merchandise transaction system illustrated in FIG. 4; and

FIG. 6 is a flow chart for describing an operation in case where a billing statement master is coincident with deposited figures.

### DESCRIPTION OF THE PREFERRED EMBODIMENT

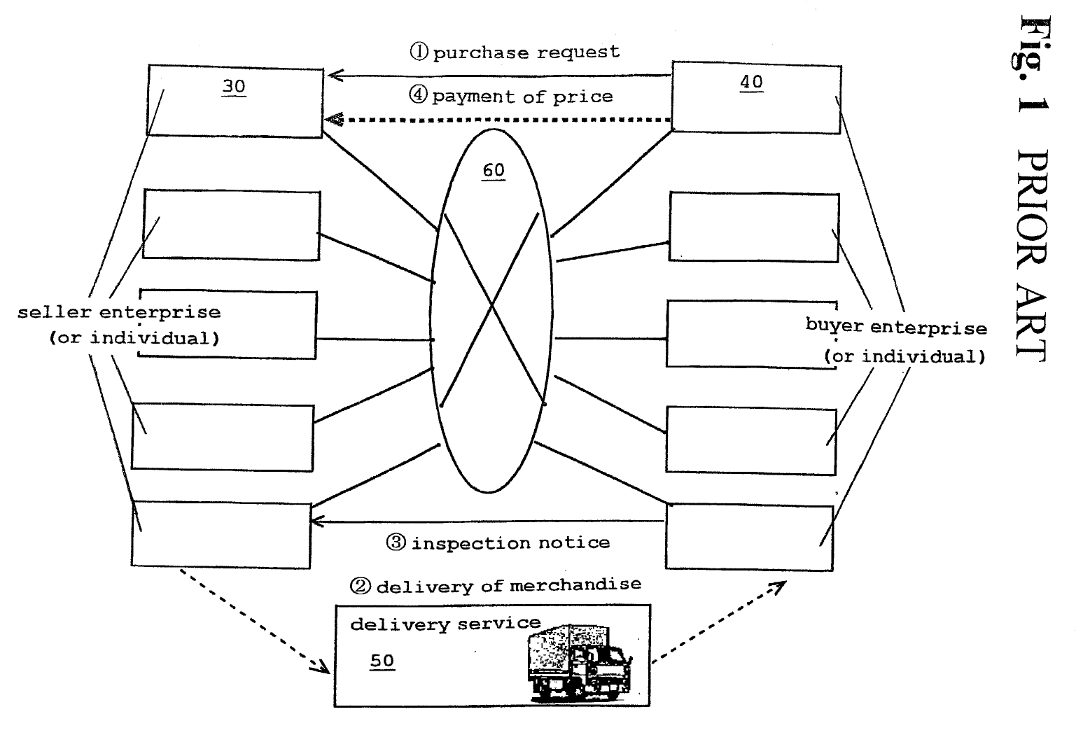

Referring to FIG. 1, a conventional merchandise transaction system will be described at first in order to facilitate an understanding of this invention. In FIG. 1, each of solid lines represents a data flow. Each of broken lines represents a merchandise flow. Each of fat broken lines represents money flow. A merchandise transaction is carried out between a plurality of sellers 30 and a plurality of buyers 40. The sellers 30 may be, for example, enterprises or individuals. Similarly, the buyers 40 may be enterprises or individuals. A transaction starts when a specific one of the buyers applies for purchase to a particular one of the sellers (\mathring{1}). Both of the specific buyer and the particular seller communicate with each other by any one of information communicating systems 60 to inform the opponent of each will, in order to make the transaction progress. The information communicating systems 60 may include an information communicating network such as public switched network or private switched network. Furthermore, the information communicating systems 60 may be, for example, mails or delivery services.

When the specific buyer applies for purchase to the particular seller, the particular seller offers an estimate to the specific buyer. The specific buyer and the particular seller may exchange contracts with each other. After the specific buyer and the particular seller exchange contracts with each other, the particular seller delivers goods to the specific buyer (\mathring{2}). As shown in FIG. 1, a distribution service may be used which is a third party, when the particular seller sends the goods to the specific buyer. When the specific buyer receives the goods, the specific buyer generally sends an inspection notice to the particular seller (\mathring{3}), in order to verify delivery of the goods. On the other hand, the specific buyer pays for the goods to the particular seller (4). Payment is carried out by cash, check, credit card or the like. After making the payment, the merchandise transaction leads to an end. Alternatively, the specific buyer may pay for the goods before the particular seller delivers the goods to the specific buyer.

As described above, merchandise delivery and payment are carried out between the particular seller and the specific buyer. Each of the particular seller and the specific buyer may be called a concerned party. Each of the particular seller and the specific buyer inevitably has a risk on the merchandise delivery and the payment. More particularly, the specific buyer may not pay for the goods even if the particular seller delivers the goods to the buyer. On the other hand, the particular seller may not deliver the goods to the specific buyer even if the specific buyer pays for the goods. In addition, the particular seller may deliver the specific buyer other goods different from the goods for which the specific buyer pays. Even if the specific buyer returns the other goods to the particular seller, the particular seller may not pay back money to the specific buyer. Taking the above-mentioned problems into consideration, it is desirable that the particular seller delivers the goods to the specific buyer after the specific buyer pays for the goods. To the contrary, it is desirable that the specific buyer pays for the goods after the goods are delivered to the specific buyer and the specific buyer makes sure whether or not the goods is wrong. However, it is impossible to give satisfaction to both of the particular seller and the specific buyer at the same time. It is necessary for at least one of the particular seller and the specific buyer to take a risk in concern to the merchandise transaction.

The risk factor is so low inasmuch as it is possible to gauge credibility on the basis of previous actual results, in case where the concerned party is under continuous merchandise transaction. In an open market, it often occurs that the particular seller has no previous transaction result for the specific buyer. In this case, it is difficult for each of the particular seller and the specific buyer to gauge mutual credibity. In order to reduce the risk for the merchandise transaction, the particular seller may deliver the goods to the specific buyer when the specific buyer pays a part of price for the goods. After the goods is delivered to the specific buyer, the specific buyer pays a remaining price for the goods. To the contrary, the specific buyer may pay the price for the goods when the particular seller delivers a part of the goods to the specific buyer. After that, the particular seller delivers a remaining part of the goods to the specific buyer. However, it is difficult to remove the risk in concern to the merchandise transaction.

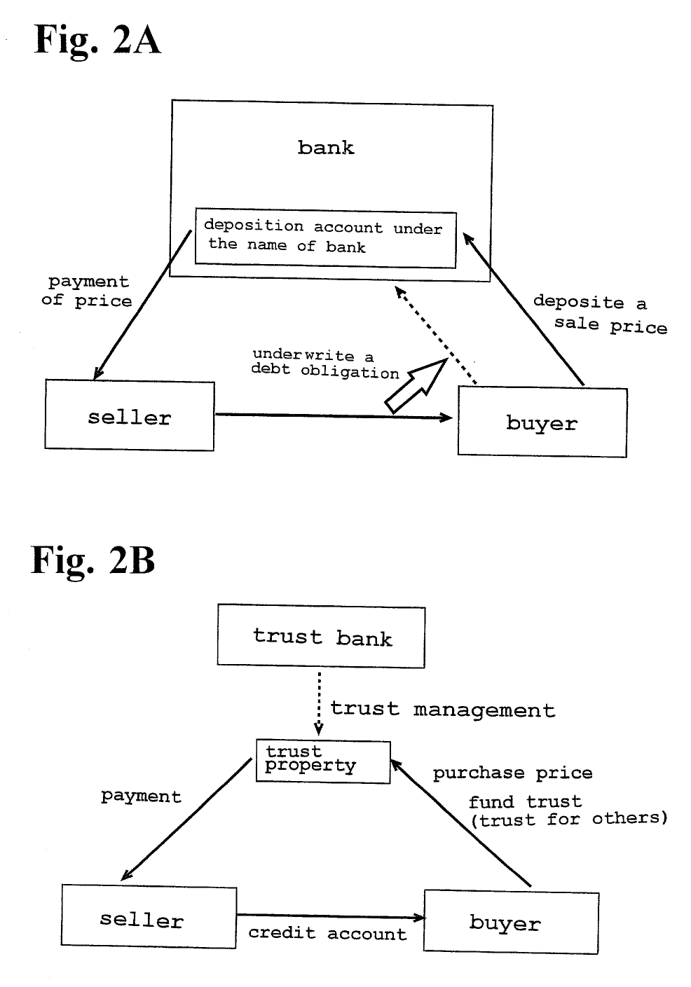

Description will proceeds to a merchandise transaction system according to a preferred embodiment of this invention. FIG. 2A shows a view for describing a concept of a merchandise transaction system of this invention in debt underwriting method. In FIG. 2A, there is a bank between a seller and a buyer. The bank underwrites a debt obligation for the buyer. In case where the seller delivers goods to the buyer, the seller has accounts receivable to the buyer. The buyer has the debt obligation. In the debt underwriting method, the bank underwrites a debt obligation for the buyer.

At first, the buyer pays a purchase price to the bank. The bank has a depositor account which is in bank's name and which will be called a bank name account. The purchase price is added to the bank name account which may be, for example, a current account, a savings account, or other accounts. When the purchase price is added to the bank name account, a conclusion of a debt underwriting contract with immunity from responsibility is automatically made between the bank and the buyer. As a result, the debt obligation for the purchase price is transferred to the bank. In addition, the buyer adds the purchase price to the bank name account on the basis of the debt underwriting contract with immunity from responsibility. The bank becomes an owner for the purchase price and becomes a debtor. Inasmuch as the bank becomes the debtor as described above, the seller is released from a risk in the credibility of the buyer. It is possible for the seller to ensure more safety in concern to the merchandise transaction. After the bank makes sure that the purchase price is added to the bank name account, the seller delivers the goods to the buyer. After the bank makes sure that the goods are delivered to the buyer, the bank supplies the purchase price to the seller. In the above-mentioned system, the bank does not supply the purchase price to the seller when the does not make sure that the goods are delivered to the buyer. Therefore, both of the seller and buyer are released from the risks in the credibility when the buyer adequately adds the purchase price to the bank name account and when the seller adequately delivers the goods to the buyer.

FIG. 2B shows a view for describing a concept of a merchandise transaction system of this invention in fund trust method. In FIG. 2B, there is a trust bank between the seller and the buyer. The buyer trusts the purchase price as a trust fund to the trust bank. In this case, the seller is a beneficiary. In comparison with the debt underwriting method, the trust bank manages the purchase price as the trust fund on the basis of trust low in the fund trust method without owning the purchase price. Even if the trust bank goes bankrupt, the trust fund is protected on the basis of the trust low. The fund trust method has a high security in another point of view in comparison with the debt underwriting method. After the trust bank makes sure that the buyer trusts the purchase price as a trust fund to the trust bank, the seller delivers the goods to the buyer. After the trust bank makes sure that the goods are delivered to the buyer, the trust bank supplies the trust fund to the seller.

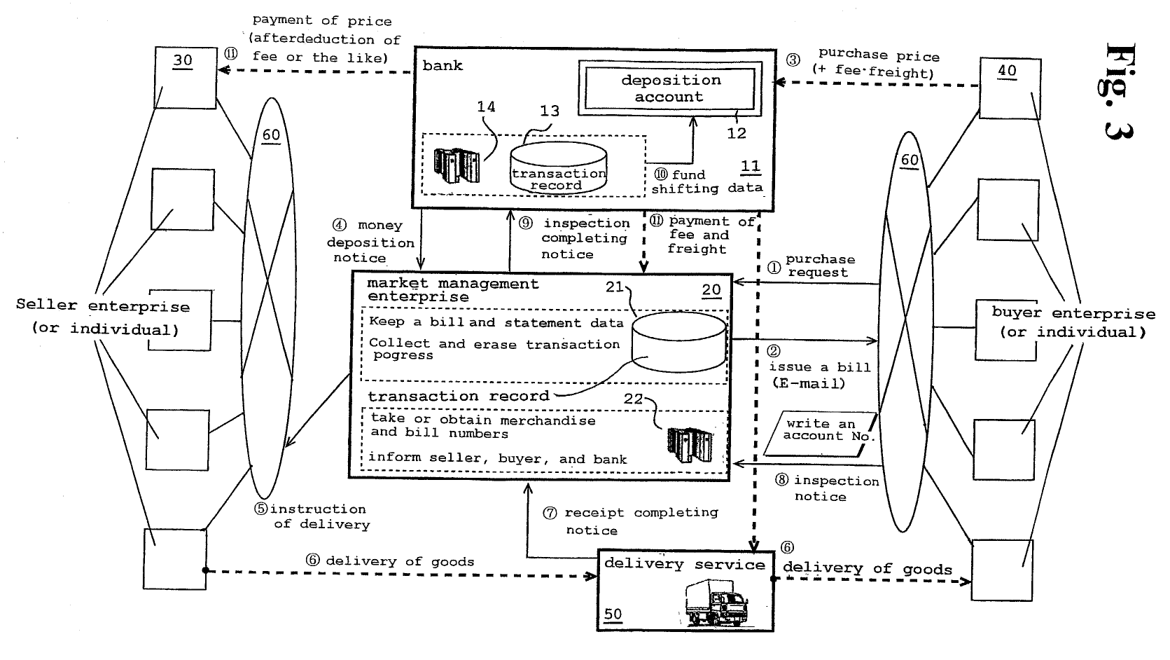

Referring to FIG. 3, description will be made as regards the merchandise transaction system according to the preferred embodiment of this invention which has functions for adequately making sure that the buyer adds the purchase price to the bank name account and that the seller delivers the goods to the buyer. In FIG. 3, the illustrated merchandise transaction system uses the above-mentioned debt underwriting method.

In the example being illustrated, four parties take part in the merchandise transaction system. More particularly, a seller enterprise (including an individual) 30, a buyer enterprise (including an individual) 40, a bank 11, and a market management enterprise 20 (which may be abbreviated to MM later) take part in the merchandise transaction system. It will be assumed that four parties take part in the merchandise transaction system in concern to the merchandise transaction and consent to use the merchandise transaction system in advance. At least one of the seller and the buyer enterprises 30 and 40 may exist in one of foreign countries.

The market management enterprise 20 serves as a business processing agency for managing the merchandise transaction system with efficiency and smoothness. The market management enterprise 20 makes or produces data for transaction between the seller and the buyer. The market management enterprise 20 communicates with each of the seller enterprise 30, the buyer enterprise 40, and the bank 11 to process data and to store the data in a data storage. Although the market management enterprise 20 is positioned as an independent enterprise in the example being illustrated, the market management enterprise 20 may not be the independent enterprise. More particularly, the bank 11 may carry out a part of the functions of the market management enterprise 20. Furthermore, the bank 11 may function as the market management enterprise 20. Namely, the bank 11 may serve as the market management enterprise 20. To the contrary, the market management enterprise 20 may carry out a part of the functions of the bank 11. When a delivery service 50 may be used on delivering the goods, it is necessary to pay money to the delivery service 50. In case of using the delivery service 50, it is possible to combine the delivery service 50 into the merchandise transaction system.

In FIG. 3, processing procedure is given by circled figures. Each of solid lines represents a data flow. Each of broken lines represents a merchandise flow. Each of fat broken lines represents a cash flow. At first, a transaction starts when the buyer enterprise 40, which wants to purchase the goods, applies for purchase to the market management enterprise 20 (\mathring{1}). A reference numeral 60 represents an information communicating system which may be, for example, an information communicating network such as Internet. E-mail may be used in the information communicating network. Furthermore, an off-line communicating means such as a mail may be used as the information communicating system. After the market management enterprise 20 receives a purchase request, the market management enterprise 20 produces or makes billing data and billing statement data for the buyer enterprise 40. The billing statement data is representative of a billing content of the billing data and is attached to the billing data. The billing data and the billing statement data will be collectively called bill and statement data later. The bill and statement data includes the billed amount for the buyer enterprise 40. In addition, the billed amount includes at least a purchase price and a prescribed fee for the merchandise transaction system. The purchase price is paid to the seller enterprise 40. The prescribed fee is paid to the market management enterprise 20. Furthermore, freight for the delivery service 60 is also included in the billed amount in case where the buyer enterprise 40 bears the freight on using the delivery service 60 in the merchandise delivery. In case where it is necessary to pay a bank fee, the bank fee is also included in the billed amount. In case where the market management enterprise 20 entrusts the third party with a part of own businesses, the expenses concerned to the entrusted business are included in the billed amount.

When the market management enterprise 60 produces the bill and statement data, the market management enterprise 60 takes a bill number for the purchase and takes an account number which is for use in adding money to the bank 11. After that, the market management enterprise 60 stores the bill and statement data in a memory device 21 and transmits the bill and statement data to the buyer enterprise 40 together with the account number.

The market management enterprise 20 has a processing apparatus 22 for carrying out processing such as data production and data input-output operation. Furthermore, the produced data and transaction records are memorized in the memory device 21.

After the buyer enterprise 40 receives the bill and statement data from the market management enterprise 20, the buyer enterprise 40 transfers money corresponding to the billed amount, into the account having the account number which is written in the bill and statement data (\mathring{3}). The account having the account number may be called an input account. The input account may be only opened in concern to the purchase in order to add money to the input account. On the other hand, the bank opens the bank name account 12 which is for use in the merchandise transaction system. The bank name account 12 is the depositor account which is in bank's name. The money transferred by the buyer enterprise 40 are further transferred to the bank name account 12 to be kept in the bank 11 during transaction. In other words, the money transferred by the buyer enterprise 40 is used as a fund which is appropriated for the purchase price by the bank 11 which underwrites the debt obligation.

The bank 11 has a processing apparatus 14 and a memory device 13. The processing apparatus 14 is for carrying out processing in concern to the merchandise transaction. The memory device 13 is for storing data such as transaction records. After the buyer enterprise 40 adds money to the input account, the bank 11 informs the market management enterprise 20 that the buyer enterprise 40 adds money to the input account (\mathring{4}). The market management enterprise 20 makes sure that payment is ensured for the merchandise price. After that, the market management enterprise 20 instructs the seller enterprise 30 to deliver the goods to the buyer enterprise 40 (\mathring{5}). After the seller enterprise 30 receives the merchandise delivery instruction from the market management enterprise 20, the seller enterprise 30 delivers the goods to the buyer enterprise 40 (\mathring{6}). In case of using the delivery service 50, the goods is delivered to the buyer enterprise 40 by the delivery service 50.

By the way, the seller enterprise may entrust the delivery service 50 with receiving the merchandise delivery instruction from the market management enterprise 20 in case of using the delivery service 50. In this case, the market management enterprise 20 directly instructs the delivery service 50 to deliver the goods to the buyer enterprise 40. Responsive to the merchandise delivery instruction, the delivery service 50 delivers the goods to the buyer enterprise 40.

When the delivery service 50 delivers the goods to the buyer enterprise 40, the delivery service 50 receives a receipt notice which is representative of completion of delivery. The delivery service 50 sends the receipt notice to the market management enterprise 20 (\mathring{7}). On the other hand, the buyer enterprise 40 also sends an inspection notice to the market management enterprise 20 (\mathring{8}). The inspection notice is representative of reception of the goods.

The market management enterprise 20 makes sure that the goods has been delivered to the buyer enterprise 40 when the market management enterprise 20 receives the receipt notice and the inspection notice. After that, the market management enterprise 20 informs the bank 11 of completion of delivery (\mathring{9}). The buyer enterprise 40 may not send the inspection notice to the market management enterprise 20. In this case, it will be assumed that the inspection notice is sent to the market management enterprise 20 after a predetermined duration lapses after the market management enterprise 20 receives the receipt notice from the delivery service 50. The market management enterprise 20 informs the bank 11 of completion of delivery even if the market management enterprise 20 does not receive the inspection notice from the buyer enterprise 40.

After the bank 11 receives a delivery completion notice, the bank 11 produces or makes fund transferring data for the seller enterprise 30 (\mathring{10}) in order to appropriate the fund which is kept in the bank name account 12, for the payment for the seller enterprise 30. The bank 11 pays the merchandise price to the buyer enterprise 30 in accordance with the fund transferring data (\mathring{11}). Furthermore, the bank 11 pays a fee to the market management enterprise 20 and pays a freight to the delivery service 50.

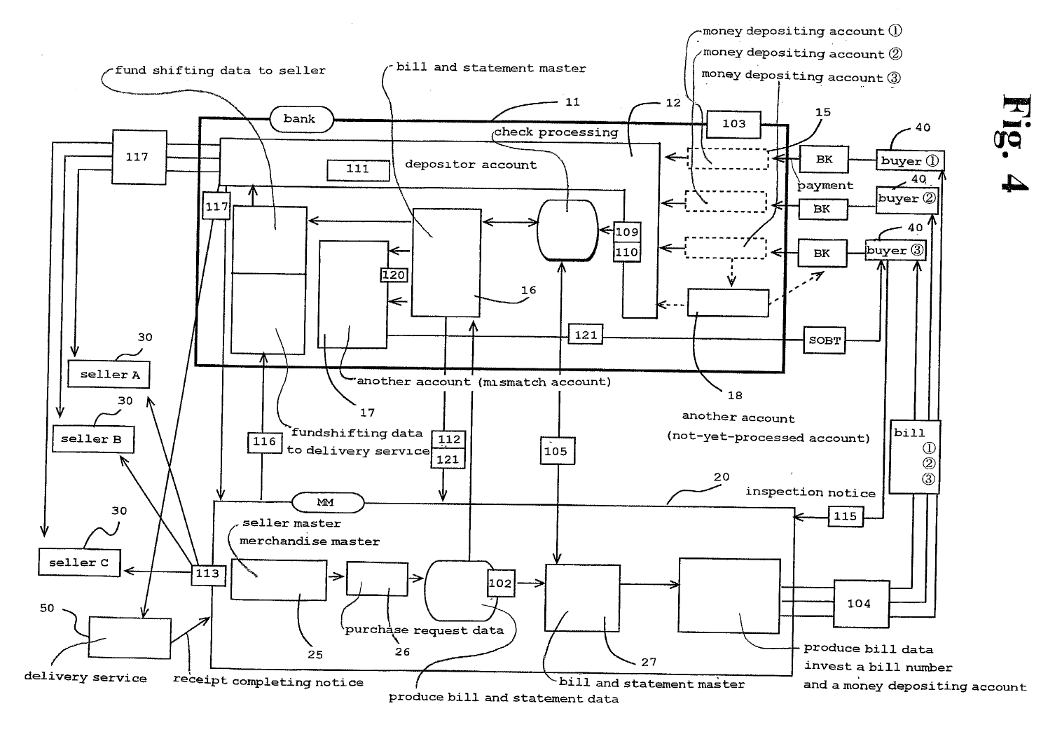

Referring to FIG. 4, illustration is made as regards a plurality of buyers (\mathring{1}-\mathring{3}) and a plurality of sellers (A-C) in FIG. 4. The market management enterprise (which may be abbreviated MM) has a database which is for use in storing information concerned to sellers and goods. The sellers have taken part in the merchandise transaction system. The goods are sold by the sellers, respectively. The database will be called a seller and merchandise master 25.

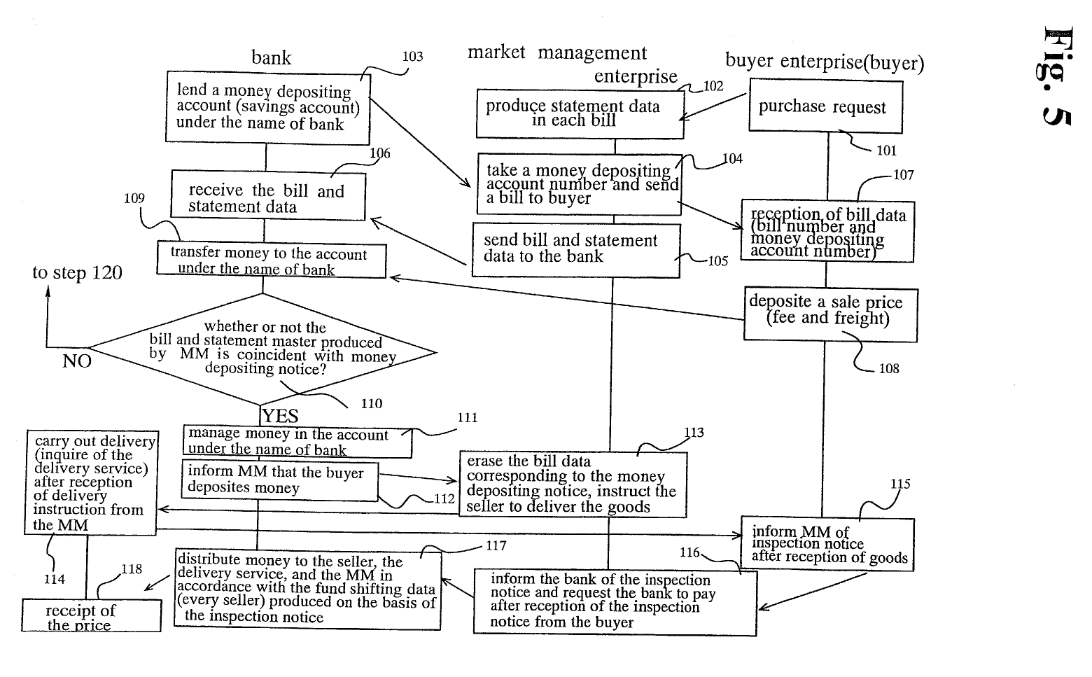

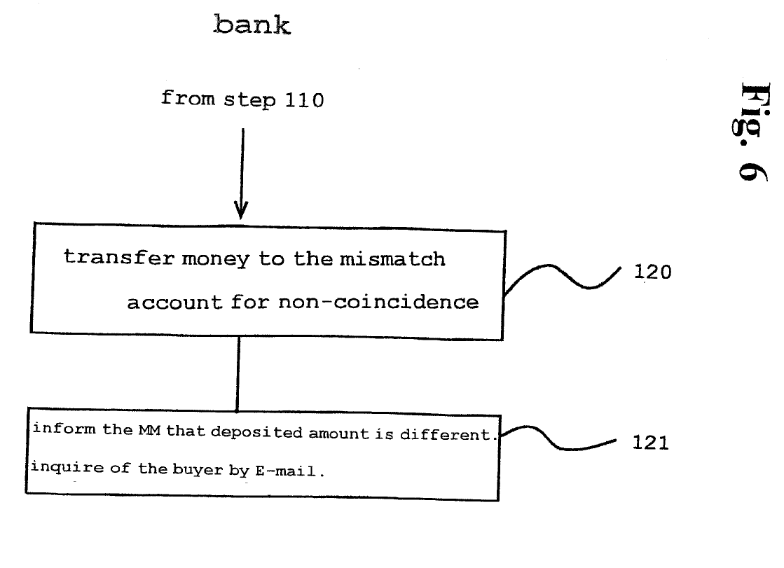

Referring to FIGS. 5 and 6 in addition to FIG. 4, a specific one of the buyers sends purchase request data 26 to the market management enterprise 20 at a step 101. The purchase request data 26 has at least one of seller names and at least one of merchandise names. When the market management enterprise 20 receives the purchase request data from the specific buyer, the market management enterprise 20 produces or makes the bill and statement data at a step 102. On making bill and statement data, the market management enterprise 20 reads the information as read information out of the seller and merchandise master 25. The read information is read out of the seller and merchandise master 25 on the basis of the purchase request data. The market management enterprise 20 makes the bill and the statement data on the basis of the read information. The bill and the statement data are produced in each of the buyers and in each purchase request. In order to adequately check on the progress of the transaction, the market management enterprise 20 takes the bill number in each purchase request. Illustration is made as regards an example of the bill and statement data in Table 1. As shown in Table 1, one purchase request may have a plurality of seller names.

TABLE 1

| | |
|---|---|
| Seller A | merchandise name, a unit price, quantity, tax, |
| | freight, fee, total payment account |
| Seller B | . . . , . . . , . . . , . . . , . . . |
| Seller C | . . . , . . . , . . . , . . . , . . . |
| . . . | |
| Delivery service | total of freights |
| MM | total of fees |
| Sum billed amount | |

At a step 104 shown in FIG. 5, the market management enterprise 20 takes an account number of the payment account which is for use in adding money to the bank. The money corresponds to the merchandise price including the fee or the like. The market management enterprise 20 sends the account number to the specific buyer together with bill and statement data. The payment account is depicted by a reference numeral 15 in FIG. 4. The payment account is only used on adding money to the bank in concern to the above-mentioned purchase request.

At a step 105, the bill and statement data is also supplied to the bank. Furthermore, the bill and statement data is memorized as a bill and statement master 27 in the memory device of the market management enterprise as shown in FIG. 4. In addition, the billed amount written in the bill and statement data is kept as a not-yet-paid money at that time.

At a step 107, the specific buyer receives the bill and statement data. At a step 108, the specific buyer transfers money as a transferring money into the payment account which is appointed by the bill and statement data. The transferring money corresponds to the billed amount written in the bill and statement data. As shown in FIG. 4, the payment account 15 may be different from each bill and statement data. In other words, the payment account is appointed in each bill and statement data.

On the other hand, the bank prepares an account which will be called the bank name account. The bank name account is lent to the specific buyer. At a step 106, the bank receives the bill and statement data from the market management enterprise 20. As shown in FIG. 4, the bank stores the bill and statement data as a bill and statement master 16 in the memory device of the bank. When the specific buyer transfers money into the payment account 15, the bank shifts or transfers the money of the payment account into the bank name account (which is depicted by a reference numeral 12 in FIG. 4) at a step 109. At a step 110 which will be called a check processing step, the bank checks or judges whether or not the transferred money is coincident with the billed amount written in the bill and statement master (which is depicted by a reference numeral 16 in FIG. 4).

Detailed description will be made as regards the steps 109 and 110. The bank may carry out the check processing step in two stages. At a first stage, the bank checks “a reception person name” and “an account number” in the payment account which is depicted by a reference numeral 15 in FIG. 4. When each of “a reception person name” and “an account number” is correct, the bank transfers the money of the payment account into the bank name account. In case where each of “a reception person name” and “an account number” is incorrect, the bank transfers the money of the payment account into another account (not-yet-processed account) which is depicted by a reference numeral 18. At a second stage, the bank checks the transferred amount and the person name on the basis of the bill and statement master 16. When the bank judges that coincidence is obtained, the bank erases the billed amount which is memorized in the bill and statement master 16. After that, the bank carries out a step 111. At the step 111, the bank manages the transferred money in the bank name account. At the same time, the bank informs the market management enterprise 20 that the specific buyer appropriately adds money to the payment account at a step 112.

When the market management enterprise 20 receives a payment notice from the bank, the market management enterprise 20 erases the billed amount memorized in the bill and statement master depicted by the reference numeral 27 in FIG. 4, in concern to an issue depicted by the payment notice at a step 113. After that, the market management enterprise 20 instructs the delivery of the goods to at least one of the sellers that will be called a particular seller. The market management enterprise 20 may instruct the delivery of the goods to a plurality of sellers.

When the particular seller receives a delivery instruction from the market management enterprise 20, the particular seller carries out the delivery of the goods at a step 114. In case of using the delivery service, the delivery service delivers the goods to the specific buyer.

When the specific buyer receives the goods, the specific buyer sends an inspection notice to the market management enterprise 20 at a step 115. In case where the delivery service delivers the goods to the specific buyer, the delivery service also sends a delivery completion notice to the market management enterprise 20.

After the market management enterprise 20 receives the inspection notice and the delivery completion notice, the market management enterprise 20 sends an inspection completion notice to the bank to request the bank to carry out a payment processing at a step 116.

After the bank receives the inspection completion notice and a payment processing request, the bank produces or makes a fund shifting data and carries out the payment processing at a step 117. At first, the bank makes the fund shifting data for the particular seller as seller fund shifting data on the basis of the inspection completion notice. In case of a plurality of sellers, the bank makes the seller fund shifting data in each seller. Furthermore, the bank makes fund shifting data for the market management enterprise 20 as MM fund shifting data. In case of using the delivery service, the bank makes fund shifting data for delivery service as service fund shifting data. The bank distributes the money kept in the bank name account, to the particular seller, the market management enterprise 20, and the delivery service on the basis of all of the above-mentioned fund shifting data. As a result, the particular seller receives the merchandise price at a step 118. Similarly, the market management enterprise 20 receives the fee. The merchandise transaction finishes in safety in concern to the above-mentioned issue.

When the bank judges that transferred money is not coincident with the billed amount written in the bill and statement master, at the step 110, the step 110 proceeds to a step 120 shown in FIG. 6. The bank shifts the money of the bank name account into a predetermined deposit account which is opened on the basis of an agreement between the bank and the market management enterprise 20. The predetermined deposit account may be called a mismatch account which is prepared on mismatch between the transferred money and the billed amount, in order to manage the transferred money when the mismatch occurs. The predetermined depositor account may be, for example, another bank name account. The predetermined depositor account may be in the market management enterprise 20.

At a step 121, the bank informs the market management enterprise 20 that the transferred money is not coincident with the billed amount. Furthermore, the bank informs the market management enterprise 20 informs the specific buyer that the transferred money is not coincident with the billed amount, in order to inquire about the mismatch between the transferred money and the billed amount.

When the specific buyer receives an inquiry from the bank, the specific buyer again adds the shortage to the payment account in accordance with the inquiry. If the transferred money exceeds billed amount, it is necessary to return the overage to the specific buyer. When transferred money is modified into modified money, the bank again carries out the check processing at the step 110. When the bank judges that the modified money is coincident with the billed amount, the merchandise transaction proceeds in a manner described above.

Description will be made as regards returning the goods to the particular seller. For the reason that the received goods are different from a desired goods on checking the received goods, the specific buyer may return the received goods to the particular seller. In this case, the specific buyer informs the market management enterprise 20 of a return notice which is representative of returning the received goods. At the same time, the specific buyer returns the received goods as return goods to the particular seller. The particular seller checks the return goods to inform the market management enterprise 20 that the received goods are returned as the return goods to the particular seller. The market management enterprise 20 informs the bank that the received goods are returned as the return goods to the particular seller. Furthermore, the market management enterprise 20 requests the bank to make fund shifting data as return fund shifting data, in order to return the transferred money to the specific buyer. The bank returns the money kept in the bank name account, to the specific buyer on the basis of the return fund shifting data.

Although the bank carries out the check processing in two stages in the above-mentioned embodiment, the bank may carry out only first stage in the check processing. In this case, the bank carries out the first stage in the check processing to supply the market management enterprise 20 with a result obtained by the first stage. The market management enterprise 20 carries out the second stage in the check processing in accordance with the bill and statement master which is kept in the market management enterprise 20. The bill and statement data produced by the market management enterprise 20 is not supplied to the bank. As readily understood from the above description, the bank does not have own bill and statement master. More particularly, the bank carries out the first stage in the check processing to inform the market management enterprise 20 of the payment notice when the specific buyer adds money to the payment account.

When the transferred money is not coincident with the billed amount, the market management enterprise 20 makes an inquiry to the specific buyer. In case where the market management enterprise 20 judges that transferred money is not coincident with the billed amount, the market management enterprise 20 informs the bank of the mismatch between the transferred money and the billed amount. The bank shifts the money of the bank name account into the predetermined depositor account which is opened on the basis of an agreement between the bank and the market management enterprise 20.

Although the bank produces the fund shifting data in response to the inspection completion notice which is supplied from the market management enterprise 20 to the bank, in the above-mentioned embodiment, the market management enterprise 20 may produce the fund shifting data to supply the fund shifting data to the bank. In case of returning the transferred money to the specific buyer, the market management enterprise 20 may produce the fund shifting data to supply the fund shifting data to the bank. At any rate, any one of the bank and the market management enterprise 20 may produce a payment statement data having a detailed content for payment. The payment statement data includes information concerned to transferring or shifting money.

In addition, payment or settlement is generally carried out by transferring money into the bank in this invention. Payment may be carried out by a selected one of a credit card, a postal transfer, an account transfer, cash on delivery, and electric money. Furthermore, the merchandise price may be paid to the particular seller from a convenience store. More particularly, the credit card agency may collect money as collected money from the seller on using the credit card. The credit card agency adds the collected money to the payment account of the bank. In case where the merchandise price is paid to the particular seller from the convenience store, a withdrawal agency may collect the merchandise price as collected money from the convenience store to add the collected money to the payment account of the bank. Even if the specific buyer uses the credit card, it is possible for the bank to return the transferred money to the specific buyer in accordance with a return request of the specific buyer in case where the specific buyer wants to return the transferred money.

Although description is made as regards the merchandise transaction system according to the preferred embodiment of this invention in accordance with the debt underwriting method, it is possible to construct the merchandise transaction system based on the fund trust method, in a similar manner described above. In case of the fund trust method, the transferred money is kept as the trust fund in the trust bank without the transferred money being kept as bank's money in the bank name account.

As described above, the bank and the market management enterprise are positioned between the concerned parties such as the seller and the buyer according to this invention. The bank keeps the merchandise price. The market management enterprise manages the progress of the merchandise transaction. Therefore, it is possible to carry out the merchandise transaction with high security and efficiency.

Inasmuch as the seller can deliver the goods to the buyer after the seller makes sure that the merchandise price is kept in the bank, it is possible for the seller to evade the risk such as the not-yet-paid price.

Furthermore, it is possible for the seller to greatly reduce the amount of the business processing inasmuch as the market management enterprise carries out the business processing concerned to a received order, a billing, and a withdrawal of bill.

In addition, it is possible for the buyer to evade the risk with the goods being not delivered and the desired goods being not delivered inasmuch as the bank keeps the money in own debt obligation until the bank makes sure that merchandise inspection is completed. Furthermore, it is possible for the buyer to easily get back the transferred money inasmuch as the transferred money has not passed into the seller yet in case where the buyer returns the goods to the seller.

As readily understood the above description, it is possible to greatly reduce uneasiness and inhibition concerned to the merchandise transaction, in the merchandise transaction system according to this invention. As a result, it is possible for the merchandise transaction system of this invention to facilitate the transaction in the open market with smooth and healthy. Furthermore, it is possible for the merchandise transaction system of this invention to greatly contribute to the energization and the development of the open market.

While this invention has thus far been described in conjunction with the preferred embodiments thereof, it will readily be possible for those skilled in the art to put this invention into practice in various other manners.

What is claimed is:

1. A system for use in carrying out a commercial transaction between a seller and a buyer with a high security, wherein said system comprises:
a bank having an account for keeping money which is deposited as input money by the buyer; and
a market management agency for communicating with the seller, the buyer, and the bank; and
first means for carrying out check processing which is for judging whether or not the input money is coincident with a billed amount of a bill and statement data when said input memory is deposited into said account, said first means producing a coincidence signal when said input money is coincident with said billed amount;
said market management agency comprising:
second means for processing information concerned to the commercial transaction, into a processed information;
third means for keeping said processed information therein;
fourth means for producing said bill and statement data having the billed amount on the basis of a purchase request of the buyer to supply said bill and statement data to said buyer and said bank;
fifth means for producing an instruction of a merchandise delivery in response to said coincidence signal; and
sixth means for informing said bank of a completing notice after delivery of the goods is completed;
said bank comprising:
seventh means for keeping said input money as kept money in said account in response to said coincidence signal; and
eighth means for paying a merchandise price within said input money to the seller in response to said completing notice.

2. A system as claimed in claim 1, wherein said fourth means makes said bill and statement data have account number data which is for use in deposing said input money into said bank, on supplying said bill and statement data to said buyer.

3. A system as claimed in claim 1 or 2, wherein at least one of said bank and said market management agency carries out said check processing.

4. A system as claimed in any one of claims 1 to 3, wherein:
said market management agency comprises:
a database for memorizing information concerned to said seller and goods of the seller, as seller data therein; and
said fourth means reading said seller data out of said database on the basis of said purchase request to produce said bill and statement on the basis of said seller data.

5. A system as claimed in any one of claims 1 to 4, wherein either one of said bank and said market management agency comprises ninth means for producing a fund transferring data representative of transferring money to said seller, as a seller transferring data, before said merchandise price is paid within said kept money to said seller.

6. A system as claimed in claim 5, wherein said ninth means further produces a payment statement data concerned to the transfer of money.

7. A system as claimed in any one of claims 1 to 6, wherein either one of said bank and said market management agency comprises tenth means for producing a fund transferring data representative of transferring money to said market management agency, as an agency transferring data, before a fee is paid within said kept money to said market management agency.

8. A system as claimed in any one of claims 1 to 7, wherein a delivery service sends a receipt completing notice to said market management agency after said delivery service delivers the goods to said buyer, in case of requesting said delivery service to deliver the goods from said seller to said buyer.

9. A system as claimed in claim 8, wherein either one of said bank and said market management agency comprises eleventh means for producing a fund transferring data representative of transferring money to said delivery service, as a delivery transferring data, before a freight is paid within said kept money to said delivery service.

10. A system as claimed in any one of claims 1 to 9, wherein there are a plurality of sellers.

11. A system as claimed in any one of claims 1 to 10, wherein:
said first means first means producing a non-coincidence signal when said input money is not coincident with said billed amount; and
said system further comprising a twelfth means for transferring said kept money to another account which is predetermined by said bank and said market management agency, in response to said non-coincidence signal, said twelfth means inquiring of said buyer about said input money.

12. A system as claimed in any one of claims 1 to 11, wherein:
said buyer informs said market management agency that said buyer returns the goods to said seller, in case where said buyer returns the goods to said seller;
said market management agency requesting said bank to return said input money back to said buyer when said buyer informs said market management agency that said buyer returns the goods to said seller; and
said bank returning said input money back to said buyer when said market management agency requests said bank to return said input money back to said buyer.

13. A system as claimed in any one of claims 1 to 12, wherein either one of said seller and said buyer exists in one of foreign countries.

14. A system as claimed in any one of claims 1 to 13, wherein said buyer uses one selected from a first method of transferring the input money into the bank, a second method of paying the input money in a convenience store, a third method of an account transfer, a fourth method of cash of delivery, a fifth method of a postal transfer, and sixth method of paying the input money by electric money.

15. A system as claimed in any one of claims 1 to 14, wherein said bank underwrites a debt obligation of said buyer.

16. A system as claimed in any one of claims 1 to 14, wherein said bank manages the input money on the basis of trust.
